(19) United States
(12) Patent Application Publication
(10) Pub. No.: US 2006/0161713 A1
(43) Pub. Date: Jul. 20, 2006

(54) Mounting a computer in a transport vehicle

(76) Inventor: Christian L. Belady, McKinney, TX (US)

Correspondence Address: HEWLETT PACKARD COMPANY, P O BOX 272400, 3404 E. HARMONY ROAD, INTELLECTUAL PROPERTY ADMINISTRATION, FORT COLLINS, CO, 80527-2400, US

(21) Appl. No.: 11/039,018

(22) Filed: Jan. 20, 2005

(51) Int. Cl. G06F 13/00

(52) U.S. Cl. 710/303

(57) ABSTRACT

An apparatus for use with a transport vehicle comprises a docking station for removably mounting a computer in an upside-down orientation to an inside the transport vehicle.

### BACKGROUND

Some transport vehicles, such as cars, minivans, sport utility vehicles (SUVs), and trucks, include a display monitor to display navigation information. Such a display monitor can also display user-selectable control elements for controlling the audio system and air-conditioning system of the vehicle. In some other vehicles, display monitors can be used to show movies, such as movies played by a video cassette player or a digital video disk (DVD) player.

Such conventional display monitors are typically permanently installed in the vehicles and thus are dedicated to the limited set of functions that have been defined by the vehicle manufacturer. Moreover, due to cost constraints, the conventional display monitors that are permanently installed in vehicles are typically relatively small, which decreases viewing enjoyment by users.

Portable video cassette players or DVD players with larger display monitors can also be used in transport vehicles. However, placement of such portable players in the transport vehicle may be awkward. In addition, portable players may pose safety hazards in the transport vehicle in the event of sudden stops or collisions.

### BRIEF DESCRIPTION OF THE DRAWINGS

FIG. 1 illustrates a vehicle having a docking station for removably docking a computer, in accordance with an embodiment of the invention.

FIG. 2 is a block diagram of the computer of FIG. 1, in accordance with an embodiment.

FIG. 3 is a perspective view of the bottom side of the computer of FIG. 1.

FIG. 4 is a perspective view of the docking station to which the computer of FIG. 3 can be docked.

### DETAILED DESCRIPTION

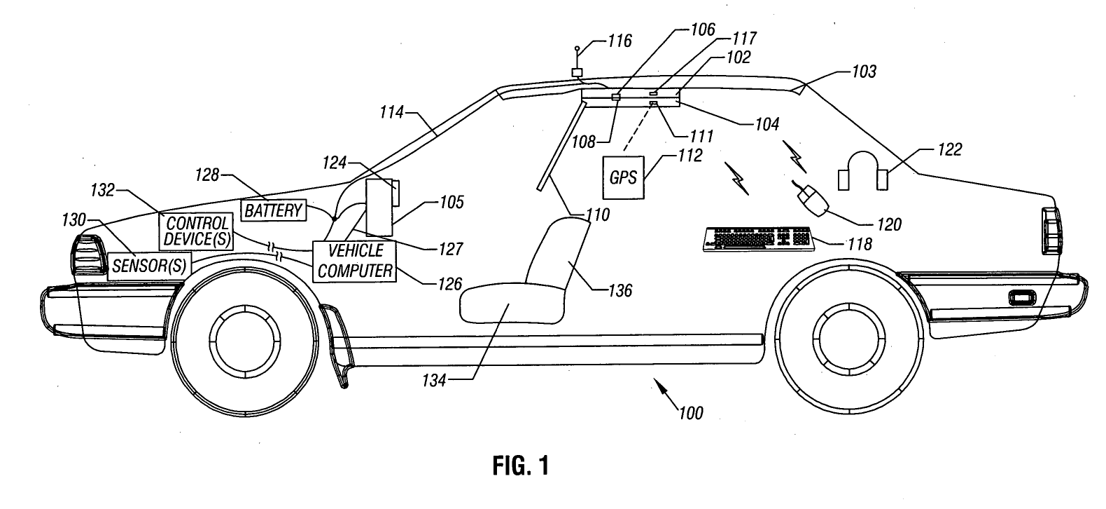

FIG. 1 illustrates a transport vehicle (such as a car, automobile, sport utility vehicle, truck, plane, train, boat, or other type of vehicle) 100 that has a docking station 102 according to an embodiment. As used here, the term “transport vehicle” means any apparatus or machine used for transporting a person or multiple persons. The docking station 102 is used for docking a computer 104, such as a portable computer, notebook computer, a personal digital assistant (PDA), or other type of computer. The docking station 102 is used to removably dock the computer 104 so that a passenger (or driver) of the vehicle 100 can remove the computer 104 after use. Consequently, the computer 104 can be used for multiple purposes: (1) for entertainment viewing and control of various features in the transport vehicle 100, and (2) for general computing tasks both inside and outside the vehicle 100. By using a general purpose computer 104 with a display monitor 110 that is removably docked in the transport vehicle 100, a larger display area can be provided as compared to conventional display monitors permanently mounted in vehicles. Also, the dockable, general purpose computer can be used in multiple, different vehicles.

In the arrangement depicted in FIG. 1 according to one embodiment, the docking station 102 is mounted to a ceiling 103 of the vehicle 100. In this manner, the computer 104 is removably docked to the docking station 102 in an upside-down orientation.

The docking station 102 is positioned at a location in the vehicle 100 that is some distance away from a front instrument console 105 of the vehicle 100. The front instrument console 105 includes various gauges and other display elements associated with the vehicle 100 (e.g., a speedometer, fuel gauge, temperature gauge, oil level gauge, battery level gauge, mileage indicator, outside temperature indicator, engine temperature indicator, warning lights, control knobs and buttons for the air-conditioning system, audio system (such as a radio, CD player, and/or cassette player), and so forth).

Also, the vehicle 100 optionally includes a display monitor 124 that is mounted to the front instrument console 105. The display monitor 124 is able to display navigation maps that are viewable by a driver. Also, the display monitor can be used to control the air-conditioning system and audio system of the vehicle 100, according to some example implementations.

In the arrangement of FIG. 1, the docking station 102 is positioned generally above the backrest 136 of a front seat 134 of the vehicle. This position allows passengers in the rear seat (not shown) to manipulate the computer 104 as well as to view the display monitor 110 of the computer 104. In a different arrangement, the docking station 102 can be mounted at a different location away from the front instrument console 105, such as on the floor of the vehicle 100 between the front seats, in a center console area between the front seats, or on a backrest 136 of one of the front seats. Each of such positions of the docking station 102 provides convenient access by a passenger in the rear seat.

Alternatively, the docking station 102 can be mounted (either on the ceiling 103 or elsewhere) at a more forward position in the vehicle 100. The more forward position of the docking station 102 enables more convenient access by a passenger or driver in the front seat 134.

The front instrument panel 105 is connected electrically by an electrical cable 127 to an optional vehicle computer 126. The vehicle computer 126 is used to control various tasks within the vehicle 100, as well as to receive information relating to the vehicle 100 from various parts of the vehicle 100, such as from sensors 130. Control of various tasks is accomplished through control devices 132 in the vehicle 100. Example sensors include a temperature sensor, RPM (revolutions per minute) sensor, vehicle speed sensor, oil level sensor, engine pressure sensor, battery level sensor, air filter sensor, tire pressure sensor, fuel injection sensor, and any other sensor that provides diagnostic information pertaining to the engine and other operational features of the vehicle 100. Control devices 132 include control devices to control the air-conditioning system, the audio system, and various features of the vehicle engine. Power to the vehicle computer 126, sensors 130, control devices 132, and front instrument panel 105 is provided by a battery 128 or a vehicle power distribution system. The battery 128 is rechargeable by the vehicle power distribution system. The sensors and control devices are examples of electrical devices of the transport vehicle.

In accordance with some embodiments of the invention, the battery 128 or vehicle power distribution system also provides power to the docking station 102 over the electrical cable 114. Thus, once the computer 104 is docked to the docking station 102, the computer 104 can be powered by the battery 128 or the vehicle power distribution system.

The docking station 102 has a docking connector 106. The docking station 102 is configured to enable docking of a computer 104, which has a mating connector 108 for connection to the docking connector 106. The connectors 106 and 108 enable communication of power between the docking station 102 and the computer 104, and also provides communication of signals between the docking station 102 and computer 104. The docking station 102 is connected to the electrical cable 114 that routes power from the vehicle battery 128. The electrical cable 114 also routes signals between the docked computer 104 and other parts of the vehicle 100, such as to the vehicle computer 126 and/or sensors 130 and/or control devices 132.

The docked computer 104 is able to perform wired communication with the vehicle computer 126 over the electrical cable 114. Alternatively, a wireless link can be provided to enable wireless communication between the docked computer 104 and the vehicle computer 128. For example, the docking station 102 can have wireless elements 117 (e.g., one or more wireless transceivers) to enable the wireless communication. Through the vehicle computer 126, the docked computer 104 can receive information from the sensors 130. The information received from sensors 130 and be displayed by the notebook computer 104 on the display monitor 110 of the computer 104. The display monitor 110 can present a graphical user interface (GUI) display. The information can be provided to the user in the form of graphs or other types of reports that can be easily understood by the user.

By providing information from the sensors 130 on the display screen 110 of the computer 104, a user can view diagnostic information pertaining to the vehicle 100. The computer 104 can determine, based on the information from the sensors 130, whether service or other maintenance is to be performed on the vehicle 100. The sensor information can be used to allow the computer 104, or a user of the computer 104, to perform diagnostics to determine if a problem with the vehicle exists. If a problem exists, or service or other maintenance is needed, the display monitor 110 can provide such a notification to the user.

The computer 104 is also able to provide control commands to control devices 132 in the vehicle. The commands can be provided through the vehicle computer 126. For example, a control screen can be displayed in the display monitor 110 through which a user can control various features of the vehicle 100, such as the air-conditioning system, audio system, and so forth.

Instead of communicating with the sensors 130 and control devices 132 through the vehicle computer 126, the computer 104 can instead communicate directly with the sensors 130 and control devices 132 through the docking connector 102 and electrical cable 114 or through the docking connector 102 and wireless elements 117. As an example, the wireless elements 117 of the docking station 102 can communicate wirelessly with the audio system, such as to play audio on the radio under control of the computer 104.

The computer 104 can also display navigation maps on the display monitor 110 (in addition to the display monitor 124 in the front instrument console 105). In this manner, passengers in the back seat of the vehicle 100 can view the navigation maps without having to look at the smaller screen on the display monitor 124 in the front instrument console 105. If the docked computer 104 is mounted in a more forward position, the driver or front passenger can also view navigation maps on the display monitor 110 of the docked computer 104.

A further feature of the computer 104 is the ability to play movies and music, such as movies and music on storage media including digital video disk (DVD), compact disk (CD), magnetic media, and other like media. Once the computer 104 is docked to the docking station 102, the display monitor 110 of the computer 104 can be flipped open and a DVD or CD medium can be inserted into a DVD or CD drive of the computer 104 for playing the content of the DVD or CD medium, in one example. The content on the DVD or CD can include entertainment content, such as a movie or music.

The display monitor 110 of the docked computer 104 can also be used to display a rearview image. The rearview image can be used in place of a rearview mirror, for example. Video cameras mounted to the rear of the vehicle are electrically connected to the docking station 102 so that video images can be transferred from the video cameras for display on the display monitor 110 of the docked computer 104.

The vehicle computer 126 and docking station 102 is also connected to an antenna 116 or other receiving device. The antenna 116 or other receiving device is capable of communicating with satellites, receiving television (TV) signals, receiving radio signals (e.g., satellite radio, FM or AM radio, etc.), communicating with base stations of cellular networks, and so forth. The signals received by the antenna 116 or other receiving device is communicated to the front instrument console 105 and/or to the docked computer 104, where the content of the received signals can be displayed in the display monitor 124 and/or display monitor 110.

The computer 104 also has an input/output port 111 for receiving a GPS (global positioning system) adapter card 112. In one example, the I/O port 111 is a Universal Serial Bus (USB) port, and the GPS adapter card 112 is a USB GPS adapter card 112. Once the GPS adapter card 112 is plugged into the I/O port 111, the computer 104 can act as a GPS device that is able to communicate with GPS satellites to obtain a position of the vehicle. In this manner, a separate GPS device is not needed for the vehicle 100, which can help reduce the cost of the vehicle 100.

Alternatively, the vehicle may already have a GPS module to receive GPS information. In this alternative implementation, the docked computer 104 is used for displaying the GPS information collected by the vehicle GPS module.

Users in the vehicle 100 can also use various peripheral devices, such as a keyboard 118, mouse 120, remote control device, and headset 122, with the computer 104. The keyboard 118 and mouse 120 are used to input data into the computer 104, whereas the headset 122 is used to receive audio output from the computer 104. The peripheral devices 118, 120, and 122 can be wireless devices that communicate via RF (radio frequency), infrared, or other types of wireless signals, with the computer 104. Alternatively, the peripheral devices can be connected by cables to the docking station 102 to enable communication between the peripheral devices 118, 120, and 122 and the computer 104. In yet another embodiment, the peripheral devices can communicate wirelessly with the wireless elements 117 of the docking station 102 to enable communication between the peripheral devices and the computer 104.

Using the keyboard 118 and mouse 120, a user can perform general computing tasks on the computer 104. For example, the computer 104 can be used for reading e-mail, browsing the web, word-processing, and so forth. Also, the keyboard and mouse can be used to navigate through screens of a graphical user interface of the display monitor 110 to view information from the sensors 130 and to control the control devices 132. With a remote control device, a user can control various aspects of the computer 104, such as during playback of a movie (to play, pause, stop, fast forward, rewind, etc.).

The computer 104 can also be used to perform telephony calls by using the headset 122 and a microphone (not shown). The telephony calls can be established through the antenna 116 and a cellular network or satellite network.

The computer 104 can also be used by passengers in the vehicle for the purpose of playing electronic games. For example, a passenger can play an electronic game on the computer 104 by himself or herself, play the game with another passenger in the vehicle, or play the game with a remote user by using communications provided by the antenna 116.

The computer 104 is securely latched to the docking station 102. Also, due to the upside-down orientation of the computer 104 once the computer 104 is docked to the docking station 102, the graphical image displayed in the display monitor 110 of the computer 104 can be flipped upside down so that the passengers (or driver) in the vehicle 100 can view the graphical image in its proper orientation.

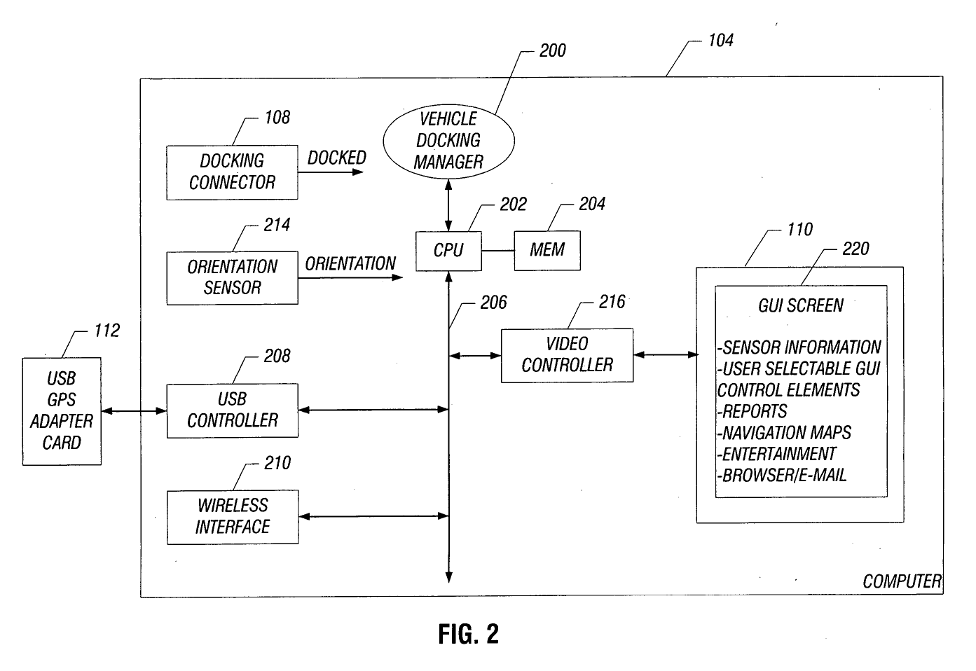

As depicted in FIG. 2, the computer 104 includes a vehicle docking manager 200, which is a software module (or collection of software modules) that is executable on a central processing unit (CPU) 202. The CPU 202 is connected to a memory 204 and a bus 206. The software module(s) making up the vehicle docking manager is made up of instructions that are contained in one or more storage media (e.g., floppy diskette, compact disk, digital video disk, and the like). The instructions can be loaded from the one or more storage media into the computer for execution by the CPU 202 to perform various tasks, as discussed below.

Through the bus 206, the CPU 202 can communicate with a USB controller 208, a wireless interface 210, and a video controller 216. The USB controller 208 communicates with the USB GPS adapter card 112, and the wireless interface 210 communicates wirelessly with peripheral devices such as the peripheral devices 118, 120, and 122 (FIG. 1).

The video controller 216 controls the output to display monitor 110 of the computer 104. A GUI screen 220 is presentable in the display monitor 110, with the GUI screen 220 displaying such example information as sensor information, user selectable GUI control elements, reports, navigation maps, entertainment content, browser content, electronic mail (e-mail) content, and so forth.

The docking connector 108 of the computer 104 provides a DOCKED signal, which is received by the CPU 202. Assertion of the DOCKED signal indicates to the vehicle docking manager 200 that the computer 104 is docked to the docking station 102 (FIG. 1). In response to docking of the computer 104 to the docking station 102, the vehicle docking manager 200 can cause the video controller 216 to rotate the image displayed in the display monitor 110 by 180° such that the graphical image is flipped upside down along with the display monitor 110. In this manner, passengers of the vehicle 100 can view the graphical image of the upside down display monitor in the proper orientation.

Instead of basing re-orientation of the GUI screen 220 on the DOCKED signal, the vehicle docking manager 200 can re-orient the GUI screen 220 based on an ORIENTATION signal from an orientation sensor 214. The orientation sensor 214 detects the docked computer 104 being in an upside-down position. If such an upside-down position is detected, then the orientation sensor 214 asserts the ORIENTATION signal, which is detected by the CPU 202 and correspondingly the vehicle docking manager 200.

In different embodiments, the computer 104 can have an orientation different from an upside-down orientation when the computer 104 is docked to the docking station 102. For example, the computer 104 can be oriented on its left or right side when docked. In this orientation, the vehicle docking manager 200 causes the image in the display monitor 110 to be rotated by 90° so that the image is properly oriented with respect to the viewer. Other orientations (e.g., 0°, 45°, etc.) of the computer 104 when docked are also possible.

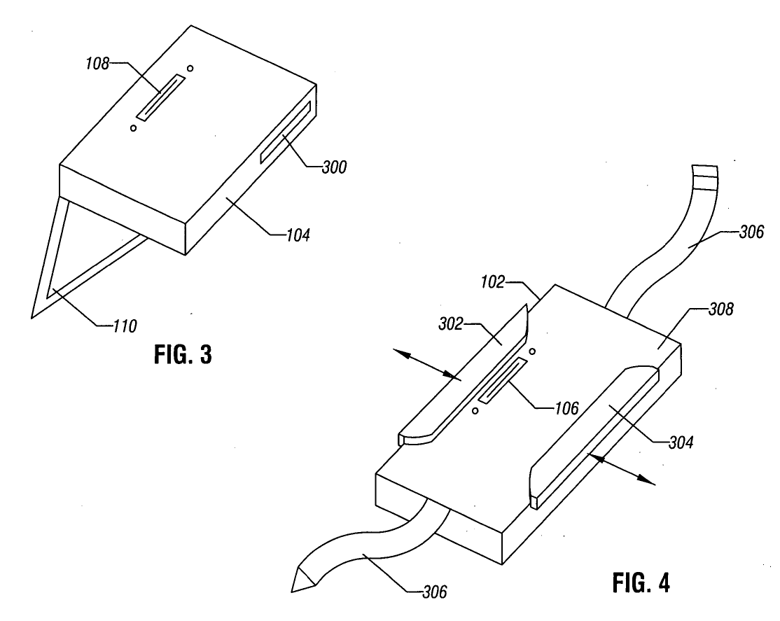

FIG. 3 shows the bottom side of the computer 104, where the mating connector 108 is located. In a different embodiment, the mating connector 104 can be provided on one of the sides of the computer 104, rather than on its bottom surface.

FIG. 4 illustrates the docking station 102 with the docking connector 106 provided on a surface 308. The docking station 102 has a pair of latches 302, 304 that are moveable in the direction indicated by the arrows to enable the insertion of the computer 104 onto the surface 308 of the docking station 102 such that the mating connector 108 can be connected to the docking connector 106. Once the mating connector 108 and docking connector 106 are connected, the latches 302, 304 (which can be spring-loaded) are engaged to a profile of the computer 104 such that the computer 104 is securely held in position by the docking station 102. For further security and safety, straps 306 attached to the docking station 102 can be wrapped around the computer 104 to further secure the computer 104 to the docking station 102.

The latches 302, 304 can be actuated by a user pulling the latches 302, 304 away from each other (by moving each latch further away from the docking station 102) to widen the gap between the latches 302, 304. The widened gap between the latches 302, 304 allows the computer 104 to fit within the gap between the latches 302, 304. The user can then release the latches 302, 304 such that a spring loading action can move the latches 302, 304 back towards each other to narrow the gap between the latches 302, 304. This action of the latches 302, 304 upon release of the user allows the latches 302, 304 to engage profiles of the computer 104 to latch the computer 104 in position with respect to the docking station 102.

In other embodiments, instead of using the latches 302, 304, other types of engagement members can be used.

According to one embodiment, the docking station 102 is a universal docking station that is able to dock to different types of computers. Such a universal docking station provides greater flexibility so that the vehicle manufacturer does not have to fit vehicles with different docking stations depending upon the type of computer the vehicle buyer wishes to use. To enable the universal docking station to receive multiple different types of computers, the spring-loaded latches 302, 304 can be pulled away from each other by a user such that the gap between the latches 302, 304 can be widened to receive the type of computer having the largest expected width. In this manner, the latches 302, 304 are actuatable to different positions (corresponding to different widths of the gap between the latches 302, 304) to receive different types of computers.

In other embodiments, other types of flexible engagement members for accommodating different types of computers (having different dimensions) can be employed.

Alternatively, the docking station 102 can be a custom docking station made for a specific computer. This type of docking station can be an after-market product that the user can mount in the vehicle 100 (FIG. 1). For example, vehicle 100 can be provided with an electrical outlet and connector that can be connected to the custom docking station.

In the foregoing description, numerous details are set forth to provide an understanding of the present invention. However, it will be understood by those skilled in the art that the present invention may be practiced without these details. While the invention has been disclosed with respect to a limited number of embodiments, those skilled in the art will appreciate numerous modifications and variations therefrom. It is intended that the appended claims cover such modifications and variations as fall within the true spirit and scope of the invention.

What is claimed is:

1. An apparatus for use with a transport vehicle comprising:
a docking station for removably mounting a computer in an upside-down orientation to an inside of the transport vehicle.

2. The apparatus of claim 1, wherein the docking station is adapted to be electrically coupled to a vehicle computer in the transport vehicle to enable the docked computer to communicate with the vehicle computer through the docking station.

3. The apparatus of claim 1, wherein the docking station is adapted to removably mount a notebook computer.

4. The apparatus of claim 1, wherein the docking station is adapted to be electrically coupled to the transport vehicle to enable the computer to receive information from a sensor in the transport vehicle.

5. The apparatus of claim 1, wherein the docking station enables the sensor to communicate information to the computer for display on the computer.

6. The apparatus of claim 1, wherein the docking station is adapted to be attached to a ceiling of the transport vehicle.

7. The apparatus of claim 1, wherein the docking station has a wireless element to communicate wirelessly.

8. The apparatus of claim 7, wherein the wireless element of the docking station is adapted to communicate wirelessly with a keyboard.

9. The apparatus of claim 7, wherein the wireless element of the docking station is adapted to communicate wirelessly with a remote control device.

10. The apparatus of claim 7, wherein the wireless element of the docking station is adapted to communicate a signal to a radio of the transport vehicle to play audio on the radio.

11. The apparatus of claim 1, wherein the docking station has at least one engagement member to flexibly adjust to a size of the computer.

12. The apparatus of claim 1, wherein the docking station is adapted to be electrically coupled to power provided by the vehicle.

13. The apparatus of claim 1, wherein the docking station is adapted to communicate with a control device of the transport vehicle to enable the computer to communicate with the control device of the transport vehicle.

14. The apparatus of claim 1, wherein the docking station has a releasable latch to releasably attach the computer to the docking station once the computer is docked to the docking station.

15. The apparatus of claim 14, wherein the docking station further comprises a strap to further secure the computer to the docking station.

16. The apparatus of claim 1, wherein the docking station has a strap to secure the computer to the docking station.

17. The apparatus of claim 1, further comprising a storage medium containing a software module executable in the computer to re-orient an image displayed by a monitor of the computer.

18. The apparatus of claim 17, wherein the software module is executable in the computer to re-orient the image displayed by the monitor of the computer to be viewable in an upside-down orientation.

19. The apparatus of claim 1, wherein the docking station is adapted to be coupled to receive global positioning system (GPS) information from a module in the transport vehicle to enable the computer to display the GPS information.

20. The apparatus of claim 1, wherein the docking station is adapted to be coupled to an antenna of the transport vehicle to enable the computer to act as a telephony device.

21. The apparatus of claim 1, further comprising the computer,
the computer having a display monitor, the computer further to display entertainment content on the display monitor of the computer.

22. The apparatus of claim 21, wherein the computer comprises a drive for loading a removable storage medium, the entertainment content displayed by the computer on the display monitor being stored on the storage medium.

23. The apparatus of claim 1, further comprising the computer,
wherein the computer is adapted to display a navigation map on the display monitor of the computer.

24. An article comprising at least one storage medium containing instructions that when executed cause a computer that is capable of being docked to a docking station to:
detect that the computer has been docked to the docking station;
in response to detecting that the computer has been docked to the docking station, adjusting an image on a display monitor of the computer to re-orient the image on the display monitor.

25. The article of claim 24, wherein detecting that the computer has been docked to the docking station comprises receiving an indication from an orientation sensor regarding the orientation of the computer.

26. The article of claim 24, wherein adjusting the image on the display monitor comprises re-orienting to image to an upside-down orientation on the display monitor.

27. A computer capable of being docked to a docking station, comprising:
a processor;
a display monitor; and
a software module executable on the processor to rotate an image on the display monitor to re-orient the image on the display monitor in response to the computer being docked to the docking station.

28. The computer of claim 27, further comprising an orientation sensor to sense an orientation of the computer when the computer is docked to the docking station, the software module executable to rotate the image on the display monitor in response to an orientation indication provided by the orientation sensor.

29. The computer of claim 27, wherein the software module is executable to re-orient the image to be viewable in an upside-down orientation on the display monitor.

30. A system comprising:
a transport vehicle having a docking station for removably docking a computer, the transport vehicle having a front instrument console, the docking station positioned a distance away from the front instrument console,
the transport vehicle having an electrical device,
wherein the docking station is electrically coupled to the electrical device.

31. The system of claim 30, wherein the transport vehicle has a ceiling, the docking station being mounted to the ceiling of the transport vehicle.

32. The system of claim 30, wherein the docking station has at least a latch to engage the computer once the computer is docked to the docking station, wherein the latch is actuatable to release the computer to enable undocking of the computer from the docking station.

33. The system of claim 30, wherein docking station is adapted to receive the computer in an upside-down orientation in response to the computer being docked to the docking station.

34. The system of claim 30, wherein the electrical device comprises a sensor to measure a characteristic of the transport vehicle, the docking station to enable the computer to receive information relating to the measured characteristic from the sensor.

35. The system of claim 30, wherein the electrical device comprises a control device to control a component of the transport vehicle, the docking station to enable the computer to communicate with the control device to control the control device.

36. The system of claim 30, wherein the transport vehicle has a vehicle display monitor to display information about the transport vehicle, wherein the vehicle display is adapted to receive information through the docking station from the computer for display.

37. The system of claim 30, wherein the transport vehicle has a vehicle computer, the docking station to enable the computer dockable to the docking station to communicate with the vehicle computer.

38. The system of claim 37 wherein the vehicle computer is adapted to perform at least one of wired and wireless communication with the computer dockable to the docking station.

39. A method of displaying information in a transport vehicle, comprising:
removably docking a computer to a docking station mounted in the transport vehicle, wherein the transport vehicle has a front instrument console, and the docking station is positioned a distance away from the front instrument console;
communicating with an electrical device of the transport vehicle with the computer; and
displaying information associated with the electrical device in a display monitor of the computer.

40. The method of claim 39, further comprising displaying entertainment content in the display monitor of the computer.

41. The method of claim 40, wherein displaying entertainment content comprises displaying entertainment content from a removable storage medium loaded in a drive of the computer.

42. The method of claim 39, further comprising displaying at least one of an e-mail message and a web page in the display monitor of the computer.

43. The method of claim 39, further comprising displaying a navigation map in the display monitor.

44. The method of claim 39, further comprising displaying video images associated with an electronic game in the display monitor.

45. The method of claim 39, wherein the transport vehicle has a display monitor separate from the display monitor of the computer, the computer presenting information for display on the vehicle display monitor.

46. The method of claim 39, wherein the transport vehicle has a vehicle computer, the method further comprising the computer docked to the docking station communicating with the vehicle computer.

47. The method of claim 39, further comprising peripheral devices wirelessly communicating with the computer while the computer is docked to the docking station.

48. The method of claim 39, wherein the docking station comprises a universal docking station, the method further comprising docking more than one type of computer in the docking station.
